(19) United States
(12) Patent Application Publication
(10) Pub. No.: US 2022/0219534 A1
(43) Pub. Date: Jul. 14, 2022

(54) Vehicle Safety System

(71) Applicant: Damon McLendon Lee, Saint Augustine, FL (US)

(72) Inventor: Damon McLendon Lee, Saint Augustine, FL (US)

(21) Appl. No.: 17/574,546

(22) Filed: Jan. 12, 2022

Related U.S. Application Data
(60) Provisional application No. 63/136,286, filed on Jan. 12, 2021.

(51) Int. Cl. B60K 35/00; B62D 53/12; B60R 11/04; B60Q 5/00; B60R 16/02

(52) U.S. Cl. CPC B60K 35/00; B62D 53/12; B60R 11/04; B60Q 5/005; B60R 16/0207; B60R 2011/004; B60K 2370/164; B60K 2370/173; B60K 2370/178; B60K 2370/21; B60K 2370/152

(57) ABSTRACT

The present invention relates to a vehicle safety system for vehicles comprising a bed-mounted hitch. The vehicle safety system comprises a variety of components which include a plurality of wiring harnesses and a tailgate switch assembly. The vehicle safety system integrates within a vehicle infotainment system to assist a driver in safely attaching a trailer to the vehicle's bed-mounted hitch as well as operating the vehicle when it is towing the trailer. The vehicle safety system is also capable of controlling the backup camera video feed displayed by the vehicle infotainment system's display screen.

### CROSS-REFERENCE TO RELATED APPLICATIONS

This application claims priority of U.S. patent application Ser. No. 63/136,286, filed on Jan. 12, 2021.

### BACKGROUND OF THE INVENTION

### A. Field of the Invention

This invention relates to a vehicle safety system for vehicles comprising a bed-mounted hitch.

### B. Prior Art

There are many situations when operating a vehicle with a bed-mounted hitch can be dangerous if proper precautions are not taken. Many types of trailers require bed-mounted hitches for towing. Bed-mounted hitches, such as fifth-wheel hitches or gooseneck hitches, assist in distributing a concentrated payload imparted by a trailer coupler to the rear axle(s) of the vehicle.

Vehicles with bed-mounted hitches often have a tailgate which is commonly positioned in an upright, closed position. When connecting a trailer to a bed-mounted hitch, a driver must remember to perform a variety of sequential steps to avoid damaging the vehicle and/or trailer before, during and after the trailer is attached to the vehicle's bed-mounted hitch. The driver must be fully alert and maintain a heightened level of awareness throughout the entire process to ensure the trailer is properly attached to the bed-mounted hitch. Unfortunately, lapses in concentration during the process can result in costly damages to the vehicle and/or trailer as well as the driver and occupants within the vehicle. What is needed is a system which assists the driver in safely connecting a trailer to a bed-mounted hitch and protects the occupants of the vehicle and the vehicle itself.

### BRIEF SUMMARY OF THE INVENTION

The present invention relates to a vehicle safety system for vehicles comprising bed-mounted hitches. The vehicle safety system, hereinafter referred to as the “safety system”, is configured to be retrofitted and integrated within a vehicle infotainment system to assist a driver when connecting a trailer to the vehicle's bed-mounted hitch. The safety system assists the driver both before and after the trailer is mechanically attached and electrically connected to the vehicle.

The safety system comprises a plurality of wiring harnesses and a tailgate switch assembly. Once the vehicle is retrofitted with the safety system, the safety system provides automatic safety alerts to the driver before (pre-installation) and after (post-installation) a trailer is attached to the vehicle's bed-mounted hitch. Prior to the trailer being attached, the safety system automatically alerts the driver when the tailgate is in an upright, closed position and the vehicle is in reverse and within a predetermined distance from an object relative to the rear of the vehicle. Such an alert prompts the driver to open the tailgate before attaching and connecting the trailer to the vehicle.

After the trailer is attached to the bed-mounted hitch, the safety system automatically alerts the driver if the tailgate is in an open position when the vehicle's transmission is not in a park position and the trailer wiring harness is electrically connected to the vehicle infotainment system. Such an alert prompts the driver to close the tailgate before towing the trailer after it has been attached and connected to the vehicle.

### BRIEF DESCRIPTION OF THE DRAWINGS

FIG. 1 is a schematic illustration of a top view of a vehicle and a trailer.

FIG. 2 is a schematic illustration of an isometric view of the vehicle and the trailer showing the vehicle in reverse, located substantially near a predetermined distance from the trailer, with the vehicle's tailgate in an upright, closed position.

FIG. 3 is a schematic illustration of an isometric view of the vehicle and the trailer showing the vehicle in a stationary position with its tailgate in a substantially horizontal, open position.

FIG. 4 is a schematic illustration of an isometric view of the vehicle and the trailer showing the vehicle's tailgate in a substantially horizontal, open position and the vehicle positioned such that the trailer's gooseneck is above the bed of the vehicle.

FIG. 5 is a schematic illustration of an isometric view of the vehicle and the trailer showing the trailer attached to and supported by the bed-mounted hitch and the vehicle's tailgate in an upright, closed position.

FIG. 6 is a schematic flow chart showing the logic used by a vehicle safety system.

FIG. 7 depicts the interconnections between various electronic components of the vehicle safety system.

### NUMBERING REFERENCE

1—Vehicle safety system
10—Vehicle
10a—Front end
10b—Rear end
11—Vehicle infotainment system
12a—Center high mounted stop light
12b—Center high mounted stop light camera
13a—Tailgate
13b—Tailgate backup camera
14—Bed-mounted hitch
15—Plurality of vehicle side cameras
20—Trailer
21—Gooseneck
22—Trailer coupler
23—Trailer drop leg
24—Plurality of trailer cameras
25—Trailer wiring harness
50—Wiring harness
51—First end
52—Second end
55—First cable
56—Second cable
57—Third cable
60—Tailgate switch assembly
70—System controller
80—OEM Wiring Harness
A—Predetermined distance

### DETAILED DESCRIPTION OF THE EMBODIMENTS

A non-limiting exemplary embodiment of a vehicle safety system 1, hereinafter referred to as the “safety system” 1, is disclosed for vehicles 10 comprising one or more bed-mounted hitches 14. The safety system 1 is detachably coupled to a vehicle infotainment system 11 to assist a driver when attaching and connecting a trailer 20 to the vehicle 10. The safety system 1 assists the driver both before and after the trailer 20 is mechanically attached and electrically connected to the vehicle 10.

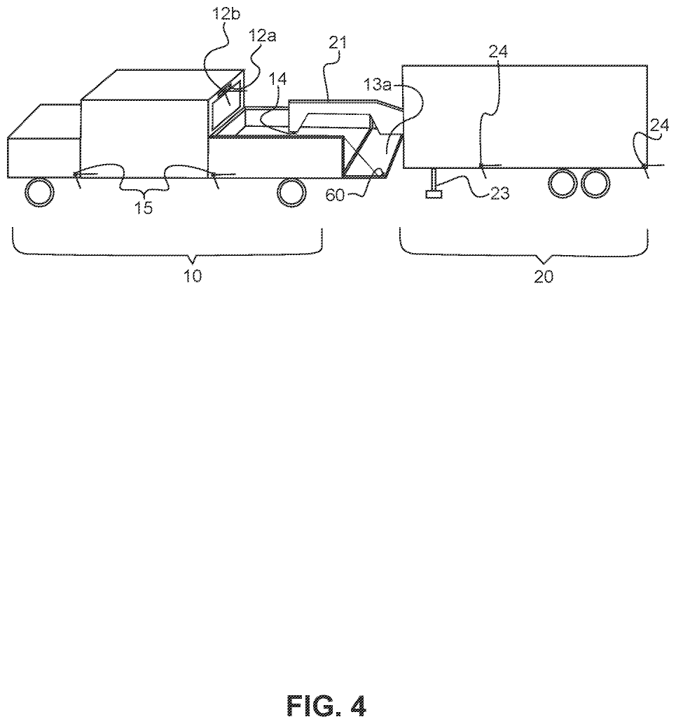

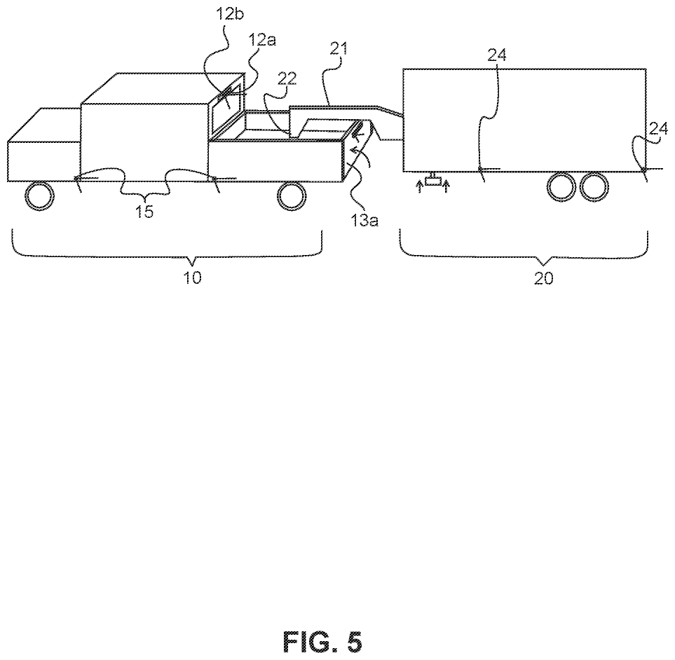

There are a variety of trailers 20 which require the vehicle 10 comprise a bed-mounted hitch 14 for towing trailers 20. In addition to the bed-mounted hitch 14, the vehicle 10 also comprises a front end 10a, a rear end 10b, a transmission, the vehicle infotainment system 11, a tailgate 13a, a tailgate backup camera 13b, a center high mounted stop light 12a, a center high mounted stop light camera 12b, and an OEM wiring harness 80. Such trailers 20 comprise a gooseneck 21, one or more trailer drop legs 23, and a plurality of trailer cameras 24. The gooseneck 21 comprises a fixed end and a free end. The fixed end is rigidly attached to the trailer 20. The free end further comprises a trailer coupler 22, which is used to mechanically attach to the bed-mounted hitch 14, as shown in FIGS. 4 and 5. The elevation of the bottom of the trailer coupler 22 is adjustable within a predetermined range. However, vehicles 10 comprising bed-mounted hitches 14 also frequently have tailgates 13a.

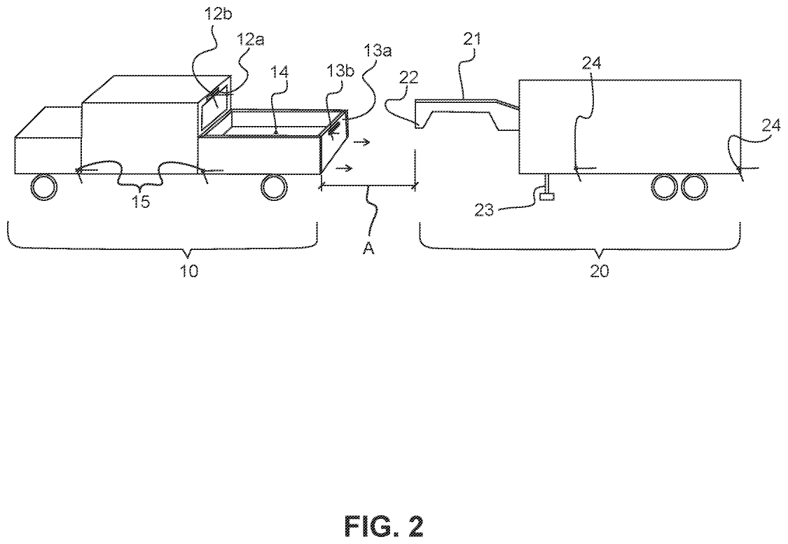

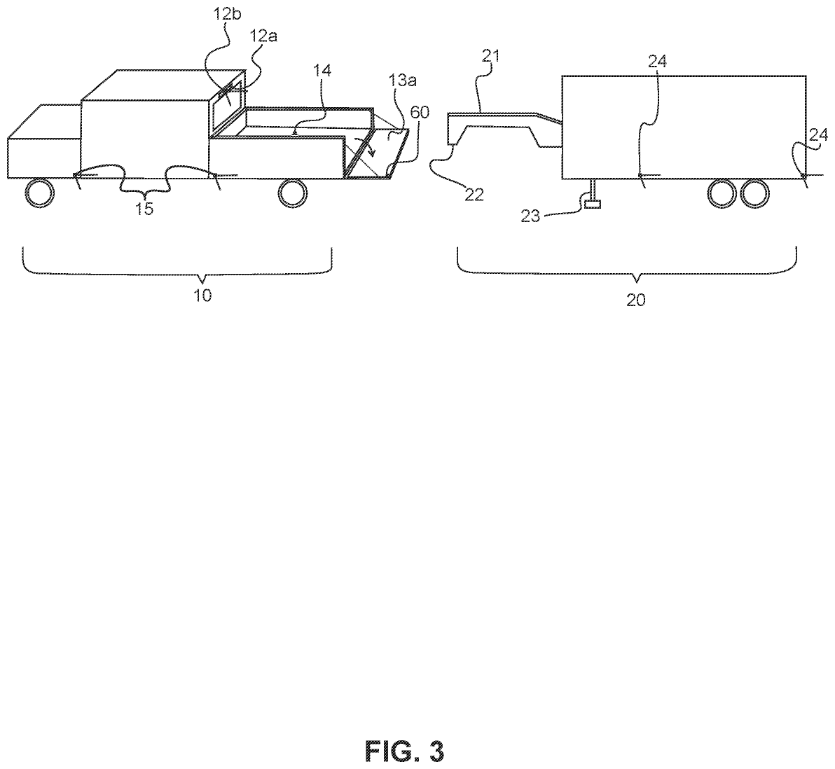

The tailgate 13a comprises a plurality of sides. The plurality of sides is further comprised of a top end, a bottom end, and two side ends. The bottom end is pivotally attached to the vehicle 10. One or more of the other sides may be secured to the vehicle 10 by one or more securement mechanisms. As shown in FIG. 2, the tailgate 13a can be oriented in a substantially upright position, hereinafter referred to as a “closed position”. Alternatively, as shown in FIG. 3, the tailgate 13a can pivot about its bottom end such that it is oriented in a substantially horizontal position, hereinafter referred to as an “open position”.

When a tailgate 13a is oriented in its closed position, it will often not allow the trailer coupler 22 to clear the top side of the tailgate 13a without the tailgate 13a colliding with the trailer coupler 22. Accordingly, most vehicles 10 require the tailgate 13a be oriented in its open position prior to positioning the vehicle 10 such that the bed-mounted hitch 14 is substantially aligned with and able to engage the trailer coupler 22. However, unfortunately, drivers often forget to open the tailgate before reversing the vehicle 10 towards the trailer 20. To overcome this problem, the safety system 1 provides a pre-installation alert notification that notifies the driver that the tailgate 13a is oriented in its closed position when the transmission is in reverse and the rear end 10b is at or within a pre-determined distance A from the trailer 20. Thus, the pre-installation alert notification mitigates the risk of the driver accidentally damaging the vehicle 10 and/or trailer 20 when the vehicle 10 is reversing towards the trailer 20.

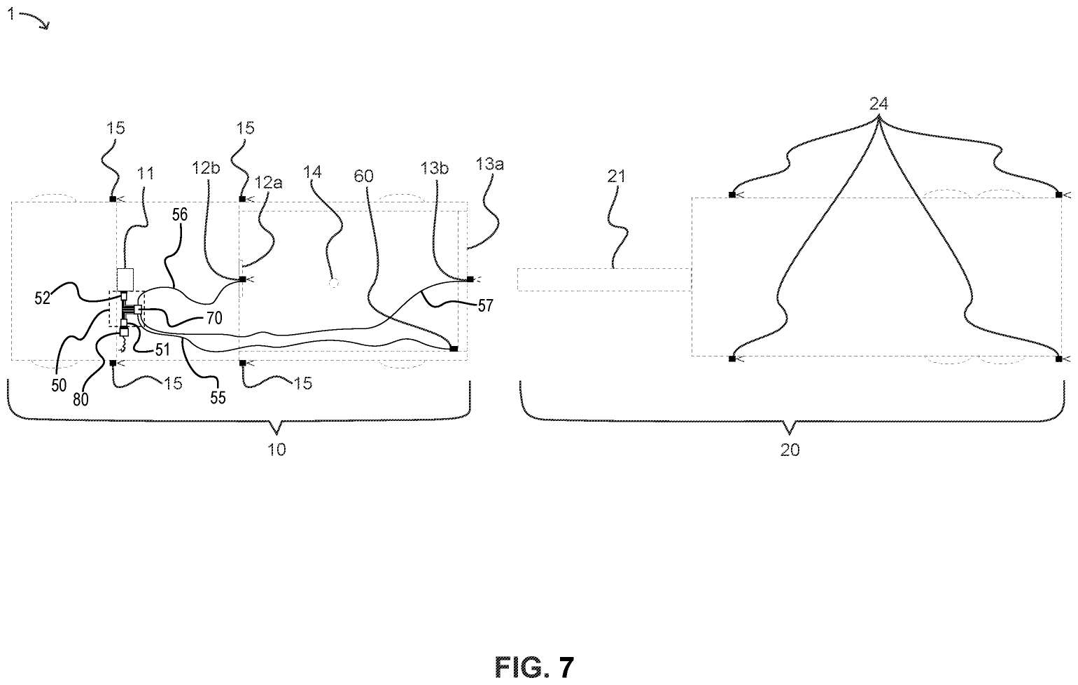

The safety system 1 comprises a wiring harness 50 and tailgate switch assembly 60. The wiring harness comprises a system controller, as shown in FIG. 7. The system controller 70 comprises a printed circuit board. The printed circuit board is configured to electronically control a variety and plurality of external components and can control one or more signal inputs transmitted to the vehicle infotainment system 11.

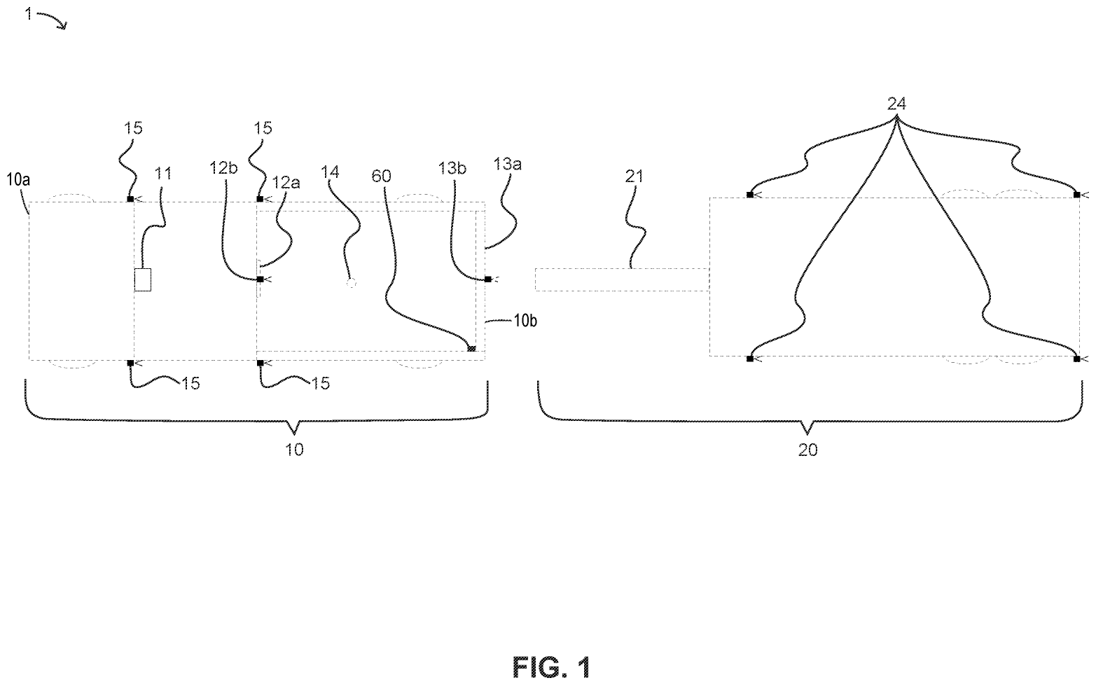

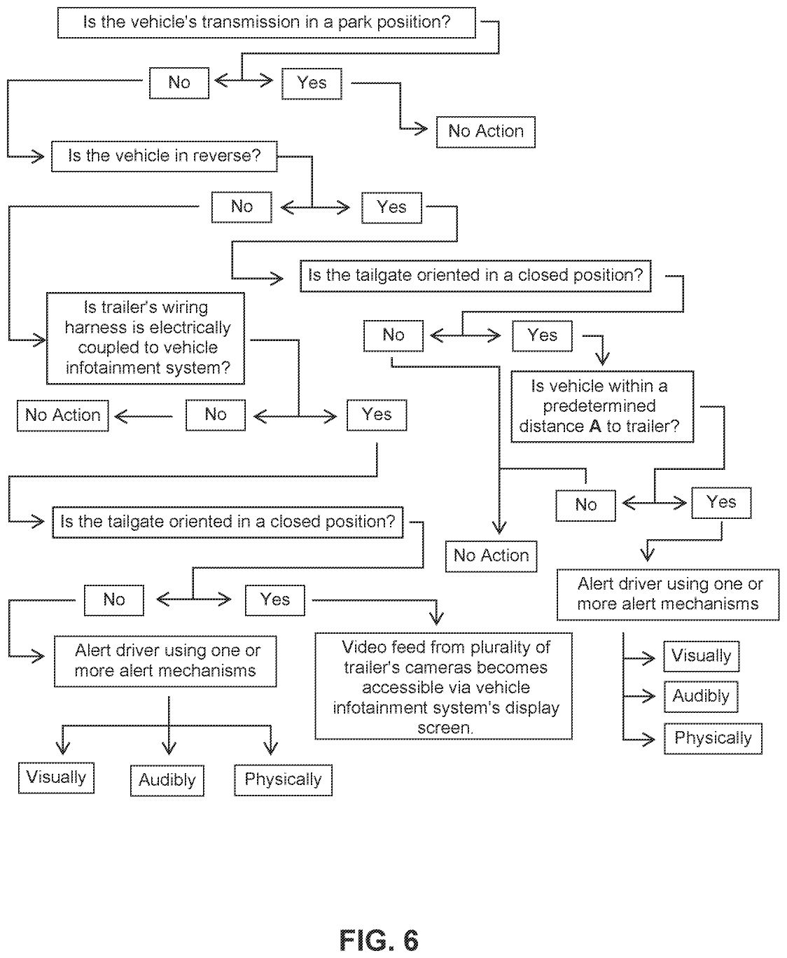

The vehicle 10 further comprises a dual backup camera system. The dual backup camera system may be factory installed or installed as an aftermarket upgrade. The dual backup camera system comprises the tailgate backup camera 13b and the center high mounted stop light camera 12b, hereinafter referred to as the “CHMSLC” 12b. The tailgate backup camera 13b is substantially positioned at the rear end 10b, as shown in FIG. 1. As shown in FIGS. 2-5, the CHMSLC 12b is located substantially adjacent to a center high mounted stop light 12a. Each camera 12a, 12b transmits a distinct video feed to the system controller 70. The system controller 70, being electronically coupled to the vehicle infotainment system 11, determines which camera's video feed is to be displayed on the vehicle infotainment system's display screen using a predetermined decision matrix. A non-limiting, exemplary embodiment of the predetermined decision matrix is shown in FIG. 6.

The wiring harness 50 comprises a first end 51, a second end 52, a first plurality of wires, and a second plurality of wires. Each end 51, 52 comprises one or more connectors. The one or more connectors may be comprised of either female or male connectors. The first plurality of wires span between the first end 51 and the controller system 70. The second plurality of wires span between the controller system 70 and the second end 52. The two ends 51, 52 are electrically coupled to the controller system 70 as well as each other. The wiring harness 50 is configured to receive and transmit electrical signals through both ends 51, 52. The electrical signals received from each end 51, 52 are transmitted to the system controller 70.

The vehicle 10 further comprises an OEM wiring harness 80. The OEM wiring harness 80 is electrically coupled to a variety of factory installed sensors and cameras within the vehicle 10. One or more of the variety of factory installed sensors configured to substantially determine the distance between the tailgate 13a and an object located behind the vehicle 11. Conventionally, the OEM wiring harness 80 is directly connected to the vehicle infotainment system 11. However, the OEM wiring harness 80 is configured to be disconnected from the vehicle infotainment system 11, without damaging the vehicle infotainment system 11, and electrically coupled to the first end 51, as shown in FIG. 6.

In an exemplary, non-limiting embodiment of safety system 1, the OEM wiring harness 80 is first disconnected from the vehicle infotainment system 11 and subsequently the one or more connectors provided by the first end 51 are electrically coupled to the OEM wiring harness 80 and the one or more connectors provided by the second end 52 are electrically coupled to the vehicle infotainment system 11. Accordingly, the OEM wiring harness is thereby electrically coupled to both the system controller 70 and the vehicle infotainment system 11.

The safety system 1 may further comprise a first cable 55, a second cable 56, and a third cable 57. Each cable 55, 56, 58 is configured to transmit video signals and, optionally, power. The first cable 55 spans between, and thereby electrically couples, the system controller 70 and CHMSLC 12b. The second cable 56 spans between the controller system 70 and the tailgate switch assembly 60. The third cable spans between the system controller 70 and tailgate backup camera 13b. Each of the cables 55, 56, 57 are preferably installed after the wiring harness is fully installed.

The tailgate switch assembly 60 is retrofitted to the tailgate 13a. However, it is also anticipated that the tailgate switch assembly 60 may be factory installed. The tailgate switch assembly 60 is communicably coupled to the system controller 70 via the second cable 56. The tailgate switch assembly 60 communicates the position of the tailgate 13a. The system controller 70 is configured to determine whether the tailgate 13a is oriented in an open or closed position. In the exemplary embodiment, the tailgate switch assembly 60 comprises a magnetic momentary switch.

Upon electrically coupling the wiring harness 50 to the vehicle infotainment system 11 and OEM wiring harness 80 and installing the second cable 56 between the system controller 70 and the tailgate switch assembly 60, the pre-installation alert notification is activated. Accordingly, when the orientation of the tailgate 13a is not in a closed position, the system controller 70 electronically disconnects the video feed of the tailgate backup camera 13b from the vehicle infotainment system 11. Subsequently, the system controller 70 switches the video feed displayed on the vehicle infotainment system's display screen to the video feed provided by the CHMSLC 12b. Thus, the driver is able to maintain a clear visual of the general area behind the vehicle 10, as well as a visual of the bed-mounted hitch 14, while positioning the vehicle 10 to attach to the trailer coupler 22.

The system controller 70 is configured to control the video feed presented on the display screen of the vehicle infotainment system 11. It is anticipated that when the tailgate 13a is in its closed position and the transmission is in reverse and within a predetermined distance A from the trailer 20 relative to the rear of the vehicle 10, the system controller 70 may modify the color of the image displayed on the display screen of vehicle infotainment system 11 to further alert the driver. When the tailgate 13a is not in its closed position, the tailgate switch assembly 60 communicates this information to the system controller 70 and the system controller 70 switches the video feed displayed on vehicle infotainment system's display screen from the tailgate backup camera 13b to the CHMSL 12b.

The automated transition of the video feed from the tailgate backup camera 13b to the CHMSLC 12b when the tailgate 13a is not in a closed position while the vehicle 10 is in reverse, ensures the driver is able to maintain a visual of the general area behind the vehicle 10. The pre-installation alert notification mitigates the risk that the driver will damage the vehicle 10 and/or the trailer 20 while attempting to attach the trailer 20 to the vehicle 10.

Once the trailer coupler 22 is mechanically attached to the bed-mounted hitch 14, the trailer wiring harness 25 must be electrically coupled to the OEM wiring harness 80. After the trailer 20 is electrically coupled to the OEM wiring harness 80, the system controller 70 automatically displays the video feed from the plurality of trailer backup cameras 24 when the transmission is in reverse. Additionally, when the OEM wiring harness 80 and the trailer wiring harness 25 are electrically coupled to one another, the safety system 1 further utilizes a post-installment alert notification to prevent the driver from towing the trailer 20 while the tailgate 13a is not oriented in a closed position.

Driving with the tailgate 13a oriented in its open position, while the vehicle 10 is towing a trailer 20, reduces the turning radius of the vehicle 10. Consequently, reducing the turning radius of the vehicle 10 can be very dangerous and may lead to costly damages to the vehicle 10 and/or trailer 20. Thus, the post-installation alert notification, being controlled and activated by the system controller 70, mitigates this risk by notifying the driver that the tailgate 13a is not oriented in a closed position while the transmission is not in park. It is anticipated that the system controller 70 may modify the color of the image displayed on the vehicle infotainment system's display screen to further alert the driver.

The pre-installation alert notification and post-installation alert notification each communicate with the driver using one or more alert mechanisms. Such alert mechanisms may comprise visual, audible, or physical alerts. Visual alerts may be displayed through the vehicle infotainment system's display screen or by a retrofitted light assembly installed within the interior of the vehicle's cabin. Audible alerts may be executed by the vehicle infotainment system 11, a retrofitted alarm assembly installed within the interior of the vehicle's cabin, or through the driver's mobile phone via a wireless connection with the vehicle infotainment system 11. Physical alerts may be utilized by the safety system 1 if the vehicle 11 is equipped with a vibrating seat feature. In such vehicles 11, the controller system 70 would communicate with the vehicle infotainment system 11 to activate the seat vibration feature.

In an alternative embodiment, the pre-installation alert notification comprises a retrofitted visual and audible alert system, using a light indicator and audible alarm, each located within the cabin of the vehicle 10. The retrofitted alert system is controlled by the system controller 70, which may either continuously or intermittently activate the pre-installation alert notification when the tailgate 13a is oriented in its closed position, the transmission is in reverse, and the vehicle 11 is within a determined distance A of the trailer 20. Additionally, the retrofitted alert system may also be utilized as the post-installation alert notification.

It is further anticipated that the safety system 1 may comprise an override switch which would allow the driver to deactivate the safety system 1.

While the embodiments of the invention have been disclosed, certain modifications may be made by those skilled in the art to modify the invention without departing from the spirit of the invention.

What is claimed:

1. A vehicle safety system comprising:
a. a vehicle;
wherein the vehicle comprises a front end, a rear end, a transmission, a vehicle infotainment system, a bed-mounted hitch, a tailgate, a tailgate backup camera, a center high mounted stop light, a center high mounted stop light camera, and an OEM wiring harness;
wherein the OEM wiring harness is electrically coupled to the vehicle infotainment system;
wherein the center high mounted stop light camera is positioned substantially adjacent to the center high mounted stop light;
wherein the tailgate backup camera is substantially positioned at the rear end;
wherein the vehicle infotainment system comprises a display screen;
b. a wiring harness;
wherein the wiring harness comprises a system controller, a first end, and a second end;
wherein the first end is electrically coupled with the OEM wiring harness and the system controller;
wherein the second end is electrically coupled to the vehicle infotainment system and the system controller;
wherein the system controller is electrically coupled to the tailgate backup camera;
wherein the system controller is electrically coupled to the center high mounted stop light camera;
wherein the system controller is configured to control the video feed displayed on the display screen;
wherein the system controller activates a pre-installation alert notification when the tailgate is oriented in a closed position, the transmission is in reverse, and the rear end is at or within a pre-determined distance from the trailer;
c. a tailgate switch assembly;
wherein the tailgate switch assembly is attached to the tailgate;
wherein the tailgate switch assembly is electrically coupled to the system controller;
d. a trailer;
wherein the trailer comprises a gooseneck and a trailer coupler;
